(19) United States
(12) Patent Application Publication
(10) Pub. No.: US 2024/0077044 A1
(43) Pub. Date: Mar. 7, 2024

(54) METHODS AND SYSTEMS FOR MOTOR-DRIVEN METERING PUMP

(71) Applicant: Woodward, Inc., Fort Collins, CO (US)

(72) Inventor: Timothy D. Gronli, Roscoe, IL (US)

(21) Appl. No.: 18/461,607

(22) Filed: Sep. 6, 2023

Related U.S. Application Data
(60) Provisional application No. 63/404,252, filed on Sep. 7, 2022.

(51) Int. Cl. F02D 41/30; F04C 14/08

(52) U.S. Cl. CPC F02D 41/3082; F04C 14/08; F04C 2270/051; F04C 2270/18; F04C 2270/19

(57) ABSTRACT

Systems and methods are provided for improving the accuracy of fuel metering for a motor-driven fuel pump, without the need for a matched-set controller. A characterization resistor value specific to the fuel pump or motor is used to calculate a fuel pump motor speed to regulate fuel delivery to an engine.

### CROSS REFERENCE TO RELATED APPLICATIONS

This application is a Non-Provisional patent application of U.S. Provisional Patent Application No. 63/404,252 entitled “Methods And Systems For Motor-Driven Metering Pump” filed Sep. 7, 2022, which is herein incorporated by reference in its entirety.

### BACKGROUND

Conventionally, fuel delivery for engine combustion has been carefully controlled by combining fuel pump types with Fuel Metering Units (FMUs) to achieve accurate fuel metering. However, this adds components and complexity within such a system, increasing size and cost while complicating maintenance, retrofitting, and system upgrades. Thus, systems and methods that improve the metering accuracy of fuel pumps sufficient to eliminate the conventional requirement for a separate, or integrated, FMU are desirable.

### SUMMARY

Systems and methods are disclosed for improving the accuracy of fuel metering for a motor-driven fuel pump, substantially as illustrated by and described in connection with at least one of the figures. In particular, a characterization device specific to the fuel pump is used to identify the performance capabilities of the fuel pump, and control fuel delivery, as disclosed herein.

### BRIEF DESCRIPTION OF THE DRAWINGS

FIGS. 1A and 1B are functional diagrams of example systems to deliver fuel to an engine, in accordance with aspects of this disclosure.

FIGS. 2, 2A and 2B provide diagrammatic illustrations of example graphic implementations of listings of volumetric efficiency values and calculations for determining a volumetric efficiency for a given fuel pump, in accordance with aspects of this disclosure.

FIG. 3 illustrates an example method of regulating fuel delivery to an engine, in accordance with aspects of this disclosure.

FIGS. 4A and 4B illustrate an example technique to determine volumetric efficiency of a pump by referencing a motor electrical phasor of the pump, in accordance with aspects of this disclosure.

The figures are not necessarily to scale. Where appropriate, similar or identical reference numbers are used to refer to similar or identical components.

### DETAILED DESCRIPTION

The present disclosure provides systems and methods for improving the accuracy of fuel metering for a motor-driven fuel pump, without the need for a matched-set controller. This is achieved by adding a characterization device specific to the fuel pump, the value of which is used to calculate a fuel pump motor speed to regulate fuel delivery to an engine.

In some examples, a characterization device (e.g., an identifier, such as a resistor) with one or more characterization device values (e.g., a resistance value), is installed in or otherwise incorporated with the fuel pump motor. A fuel pump motor controller is configured to receive and/or read the device value(s), which is used to tailor a volumetric efficiency estimate for a specific fuel pump to more accurately set pump operation and/or speed, and therefore fuel delivery, to obtain the desired fuel delivery rate to operate the engine, without having to be a matched motor-pump and controller set.

As such, in some examples the fuel pump motor controller accesses a listing correlating volumetric efficiencies to specific pumps or pump types, based on the value (e.g., resistance value) of the characterization device (e.g., a characterization resistor). For instance, upon receipt of a fuel flow command from an engine controller, the fuel pump motor controller identifies one or more operating parameters of the fuel pump based on the corresponding volumetric efficiency for the identified fuel pump. The fuel pump is then controlled according to the one or more operating parameters (e.g., temperature, speed, timing, flow rate, etc.).

In some examples, additional data (e.g., temperature, pressure, etc.) associated with the fuel pump is monitored and/or received (e.g., by one or more sensors, input by one or more interfaces, etc.), at the fuel pump motor controller. The fuel pump motor controller can adjust operation (e.g., speed) of the fuel pump in response to the monitored and/or received data falling outside a range of predetermined threshold values, which may similarly correlate to the specific pump identified by comparison to the resistance value (e.g., in the listing, in a connected list of values, calculated at a processor of the fuel pump motor controller, etc.).

Accurate fuel metering is important in controlling combustion in many engines, such as air breathing engines. Typical combustion engine powered vehicles, such as those in aerospace, employ fuel metering systems that rely on a gearbox-driven fuel pump. In operation, the gearbox-driven fuel pump provides an excess supply of pressurized fuel based on engine speed, independent of an amount of fuel needed to power the engine. In some examples, a separate FMU receives fuel flow values and timing data from an engine controller and carefully meters the excess flow from the pump down to the level needed for optimum engine operation

Although several functions of the system are described as being controlled via the engine controller 12 and/or the fuel pump motor controller 14, in some examples, a single controller could be employed to control the operation of the disclosed system functions. In some examples employing multiple controllers, the controllers could work in concert (e.g., be synchronized, receive instructions from a master controller, etc.), the controllers could operate independently, and/or be selectively controlled to cooperate during specific operational segments (e.g., at start-up). Moreover, the various controllers may be collocated within the system, or could be arranged separately (e.g., proximate to a controlled component).

Some vehicles do not employ a gearbox, and therefore require another mechanism to drive the fuel pump and therefore deliver fuel to a combustor. In some examples, employing a motor-driven fuel pump enables fuel systems to operate without the use of a gearbox, as well as controlling pump speed independently of engine operating conditions (e.g., speed), thereby enabling the fuel pump to meter fuel flow without employing an FMU.

Due to variations inherent to the manufacturing process of various pump types, the flow delivered from any given pump (such as those based on motor shaft speed) is not known with a level of accuracy required to efficiently and effectively deliver fuel for modern fuel metering systems. Accordingly, systems and methods to improve the metering accuracy of a motor-driven fuel pump is desired, such as systems that do not employ or require additional FMUs.

In disclosed examples, systems and methods employ a brushless direct current (DC) motor configured to drive a fixed displacement pump (such as a gear pump) to provide fuel flow that varies nearly linearly with speed of the motor. The motor is connected to and/or controlled by a fuel pump motor controller configured to receive one or more fuel flow commands, such as from a vehicle, and/or an engine controller.

In some disclosed examples, one or more lists (e.g., lookup tables (LUT), matrices, algorithmic functions, etc.) are accessible to and/or contained within the controller (logically and/or physically) to provide an expected, calculated, and/or nominal volumetric efficiency of the pump as a function of one or more fuel pump operating parameters. Example fuel pump operating parameters may include one or more of speed of the motor, volumetric flow, pump discharge pressure, and/or fuel temperature. For example, the one or more fuel pump operating parameters can be accessed by the fuel pump motor controller and/or via a network interface connected to data source (e.g., a remote computer).

In some examples, the fuel pump motor controller includes and/or is configured to access additional lists and/or logical functions that provide known or expected standard deviations of volumetric efficiency as a function of the fuel pump operating parameters. For instance, the values within the listing of volumetric efficiency represent the known and/or expected fuel pump types that the fuel pump motor controller could be mated with and/or control.

Based on the available information, the fuel pump controller is configured to determine and/or otherwise calculate a desired motor speed, N_{cmd}, from the commanded fuel flow rate, Wf_{cmd}, based on the following Equation 1:

$${N}_{cmd} [ rpm ] = \frac{{Wf}_{cmd} [ lbm / sec ] \cdot 60 [ sec / min ]}{ρ ( T ) [ lbm / {in}^{3} ] \cdot Disp [ {in}^{3} / rev ] \cdot {η}_{v} ( N , P , T , R )} \qquad Equation 1$$

Where:
ρ(T) represents fluid density calculated based on fluid temperature (T)
Disp represents pump theoretical displacement
η_{ν} represents pump volumetric efficiency as a function of speed (N), pressure (P), temperature (T), and characterization resistor value (R), calculated based on the following Equation 2

η_{ν}(N,P,T,R)=η_{νnominal}(N,P,T)+K(R)η_{ν1σ}(N,P,T) Equation 2
Where:
K(R) is based on characterization resistor value (R). For example, one value of R may map to K=0 such that the fuel pump motor controller will use a nominal volumetric efficiency for a given fuel pump. A different pump may present a different value of R that maps to K=−0.3 such that the fuel pump motor controller uses the nominal volumetric efficiency minus a 0.3 standard deviation.

In some examples, the characterization resistor could be configured to include one or more discrete sets of resistance values. For instance, each resistance value could be mapped to a discrete K(R) value (e.g., 0, +0.2, −0.2, +0.4, −0.4, etc.). Alternatively, the fuel pump motor controller could accept a continuously variable resistance and calculate K values according to K=f(R). For example, K=0.003 (R−1000) would return K=0 for a resistor value of 1000 ohms, or K=0.9 for a resistor value of 1300 ohms

Accordingly, systems and methods that employ a characterization resistance for a given fuel pump or fuel pump motor ensures fluid flow is metered efficiently in accordance with corresponding fuel pump operating parameters in view of engine command controls.

Although in some examples the characterization device is defined as a resistor having a particular resistance value, in some examples the characterization device is additionally or alternatively a physical or mechanical device (e.g., an inductor, a capacitor, a resolver offset, etc.), a visual device (e.g., a quick response (QR), bar code, text, graphical indication, etc.), and/or electromagnetic signal (e.g., a signal from a radio frequency (RF) tag, etc.) and/or other type of indication corresponding to a characterization value and/or the characterization device 22.

As used herein, a fuel pump transfers fuel from a fuel tank to a combustor of an engine.

As used herein, a fixed-displacement pump is a pump where flow can only be changed by adjusting a speed to the pump.

As used herein, a combustor is a component of an engine where combustion takes place.

As used herein, an airbreathing engine is an engine that produces thrust from energy produced after first taking in atmospheric air, followed by compression, heating and expansion back to atmospheric pressure through turbines and/or a nozzle.

As used herein, a circuit includes any analog and/or digital components, power and/or control elements, such as a microprocessor, digital signal processor (DSP), software, and the like, discrete and/or integrated components, or portions and/or combinations thereof.

As used herein, the terms “first” and “second” may be used to enumerate different components or elements of the same type, and do not necessarily imply any particular order. For example, while in some examples a first compartment is located prior to a second compartment in an airflow path, the terms “first compartment” and “second compartment” do not imply any specific order in which airflows through the compartments.

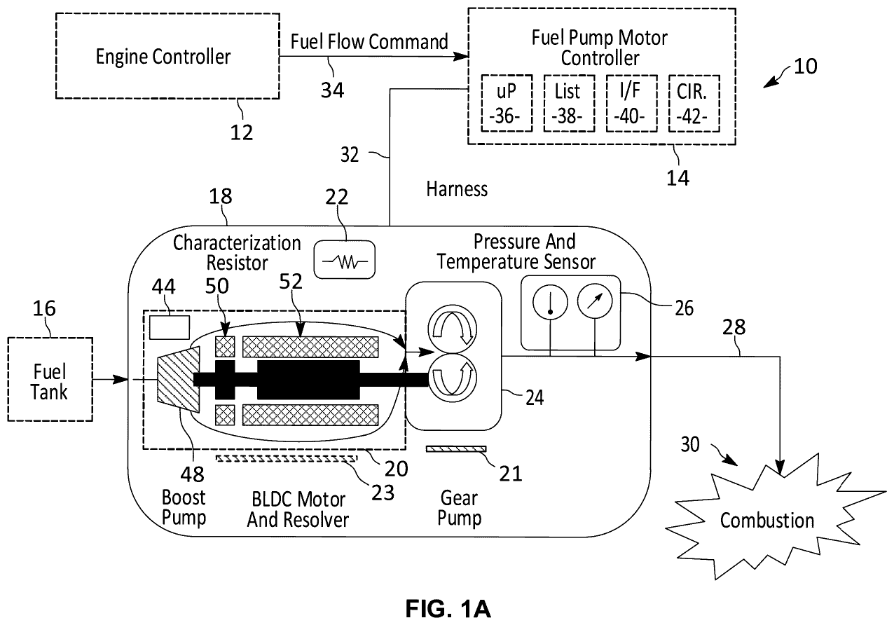

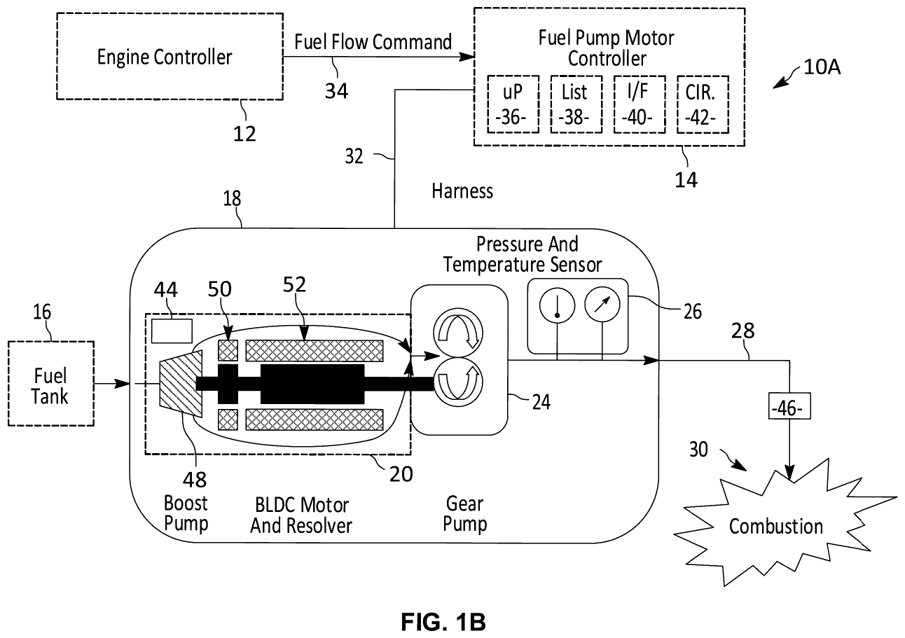

FIG. 1A is a functional diagram of an example system 10 to deliver fuel to an engine. As disclosed herein, the system 10 includes one or more of a fuel pump 18 having one or more of a fuel pump motor 20, a fixed displacement pump 24, and/or one or more sensors 26 (e.g., a pressure sensor, a temperature sensor, a densimeter, a flow meter, etc.). In some additional or alternative examples, the pump 24 could be or include a variable displacement pump, where fluid displacement and/or speed are varied to achieve a desired fuel flow. A characterization device or resistor 22 is integrated with or otherwise electrically connected to the fuel pump motor 20. Connected to or integrated with the fuel pump 18 is a fuel pump motor controller 14, which is configured to control the fuel pump motor 20 to regulate fuel metering to an engine 30. For instance, the fuel pump 18 delivers fuel from fuel source/tank 16 to the engine 30 (e.g., a combustor) via one or more channels 28. In some examples, the fuel pump motor 20 can include one or more components, including a boost pump 48, a resolver 50, and/or a motor 52.

An engine controller 12 is connected to and/or in wired and/or wireless communication with one or both of the engine 30 and the fuel pump motor controller 14 (e.g., via communications link 34). The fuel pump motor controller 14 includes one or more components and/or circuitry such as a microprocessor/controller 36, a memory storage device 38 (e.g., including a listing, matrix, library, etc.), and/or one or more interfaces 40 (e.g., including a user interface, a network interface, a communications interface, etc.). The fuel pump motor controller 14 is further connected to and/or in wired and/or wireless communication with the fuel pump 18 via channel 32 (e.g., to transmit control and/or command signals via digital or analog electric signals, mechanical changes, hydraulic changes, etc.).

In some examples, the fuel pump motor 20 receives power (e.g., electrical and/or mechanical power) from a power source (e.g., a battery, a generator output, an engine, a motor, etc.). The fuel pump motor controller 14 is configured to regulate power delivery at the fuel pump motor 20, by controlling operation of one or more circuits 42 (e.g., control circuits, power conversion circuits, etc.). Although circuits 42 are illustrated as located on the fuel pump motor controller 14 in the example of FIG. 1A, in some examples the circuits 42 can be located on or integrated with the fuel pump 18. Further, in some examples, the fuel pump motor controller 14 and associated circuitry is located on or integrated with the fuel pump 18. Furthermore, the example system 100 may include other components not specifically discussed herein.

Although the system 10 is described as employing a single characterization device 22, in some examples, multiple devices (e.g., 2, 3 or more) per pump can be employed to provide greater resolution of corresponding characterization values for a given pump.

In some alternative or additional examples, multiple characterization devices are arranged in a manner to predictably alter power characteristics flowing through the multiple devices. For instance, two or more characterization resistors can be arranged in series or in parallel, and/or one or more characterization resistors can be arranged in parallel or series with another device already on the motor-pump, such as one or more resolver wires. In such an example, the resistance value(s) may still be read at startup or another operating point, even as additional wires (e.g., to read the resistor values) are not required. For example, additional wiring to monitor characterization device values are not added to the harness 32, as no dedicated wires for the characterization device are required. In some additional or alternative examples, dedicated wiring from a characterization device may extend from the device and/or the system 10, to be read by a controller (e.g., engine controller 12 and/or fuel pump motor controller 14).

In some alternative or additional examples, a distance sensor 21 can be employed with the characterization device and/or instead of such a device. For example, the distance sensor (e.g., a linear variable differential transformer (LVDT), a hall-effect sensor, etc.) can be used to measure a distance, and that distance is then incorporated in the units at assembly of the pump (rather than installing a resistor as a characterization device). In some examples, a threaded distance adjuster 23 (e.g., a threaded rod) may be easier to set at assembly and provide better resolution than installation of discrete resistor values. For instance, a gap between a threaded rod can be set and/or measured with an integrated distance sensor, such that the gap distance is used to characterize the type of pump being used. For example, the distance can be described as the gap between a hall-effect sensor in a fixed location and a target, which can have a variable relative location. An output signal from the hall-effect sensor corresponds to a known relationship based the distance between the target and the hall-effect sensor, allowing the fuel pump motor controller to regulate operation of the fuel pump based on one or more characteristics of the output signal. The specific output signal can be compared against a list of output signals (e.g., stored in memory storage device) corresponding to distances, as well as specific fuel pumps or pump operating parameters, which can be used by the fuel pump controller to regulate operation of the fuel pump.

FIG. 1B is a functional diagram of an example system 10A to deliver fuel to an engine. Where similar components are presented, reference numerals corresponding to FIG. 1B are used in FIG. 1B. As shown, the system 10A includes fuel pump 18 having one or more of a fuel pump motor 20, a pump 24, and/or one or more sensors 26. Rather than employing the characterization resistor 22 of system 10, example system 10A measures one or more operating parameters of the pump, using this data to calculate a volumetric efficiency of the pump.

In some fuel pumps, fuel pump units and variations thereof tend to be more pronounced at low speed and high pressure difference. One technique to characterize pump leakage is to operate the pump for a predetermined duration at a defined operating point (e.g., motor speed, pressure differential, flow volume, etc.) with a known downstream flow restriction. The one or more sensors measure discharge pressure at the pump, calculated as a function of the actual pump flow, restriction size, fuel type, and/or temperature. If one or more of the restriction size, fuel type, and temperature are preset (e.g., non-variable), then the pump flow at the given pump speed can be determined and volumetric efficiency of the pump calculated or otherwise determined (e.g., in accordance with Equations 1 and 2). This information (e.g., volumetric efficiency at a given operating point) can then be used to estimate pump performance at one or more additional or alternative operating points.

In the example system 10A, volumetric efficiency is determined based on measured pump output, rather than a characterization resistor as described with respect to system 10. An example benefit of this approach is that the characterization point can be run at the beginning of each operating cycle, allowing effects of wear to be compensated for throughout the operational life of the motor-pump. In other words, determining the volumetric efficiency is based on the condition of the pump at the time it is measured, which may change over time. The information captured regarding pump operational efficiency can also be used to inform maintenance requirements, for example.

Some engines begin operation by an initial start sequence, which may serve as a useful operating point for collect pump output measurements. Advantageously, start and/or calibration sequences are often operating at low fuel flow levels, and therefore low pump speed, such that a variable downstream restriction device 46 (e.g., an adjustable valve) could be used to set a sufficiently high pressure drop by which to characterize the condition of the pump.

In some examples, a user can set the downstream high pressure value (e.g., at the device 46, by adjusting a physical valve, controlling an electro-mechanical valve via an interface, etc.). Advantageously, this could be used to increase the pressure at lower motor speeds, and/or to reveal leaks at the pump, as the pump pressure may not match the expected pressure output due to the slow resistance from the device 46.

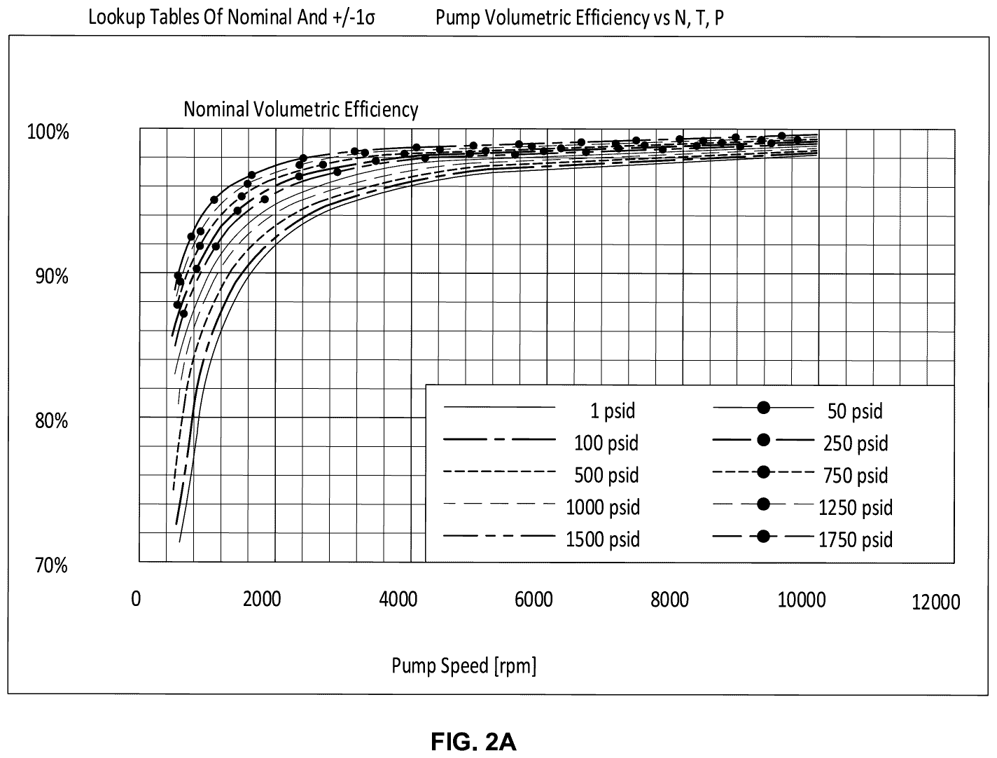

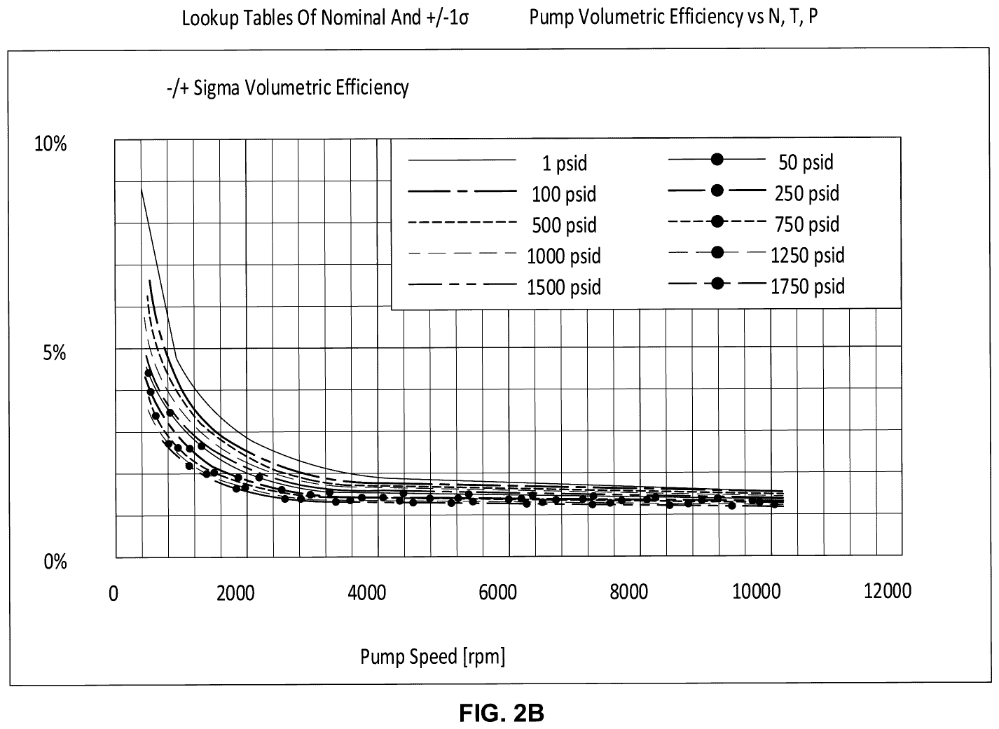

FIGS. 2A and 2B provide example implementations of lists or lookup tables 38 providing volumetric efficiency of various fuel pumps, as disclosed herein. As shown, FIG. 2A illustrates a range of values of fuel pump speed (in rotations per minute, rpm) correlated to nominal volumetric efficiency (percentage—for pumps employing a given fluid type at various operating temperatures and pressures), whereas FIG. 2B illustrates a range of values of fuel pump speed (in rpm) correlated to a standard deviation (e.g., ±1σ) volumetric efficiency (percentage). The lists 38 are accessed and the nominal volumetric efficiency values and/or standard deviation volumetric efficiency values are employed to determine an operating volumetric efficiency of the given fuel pump, based on the resistance value of the corresponding characterization device.

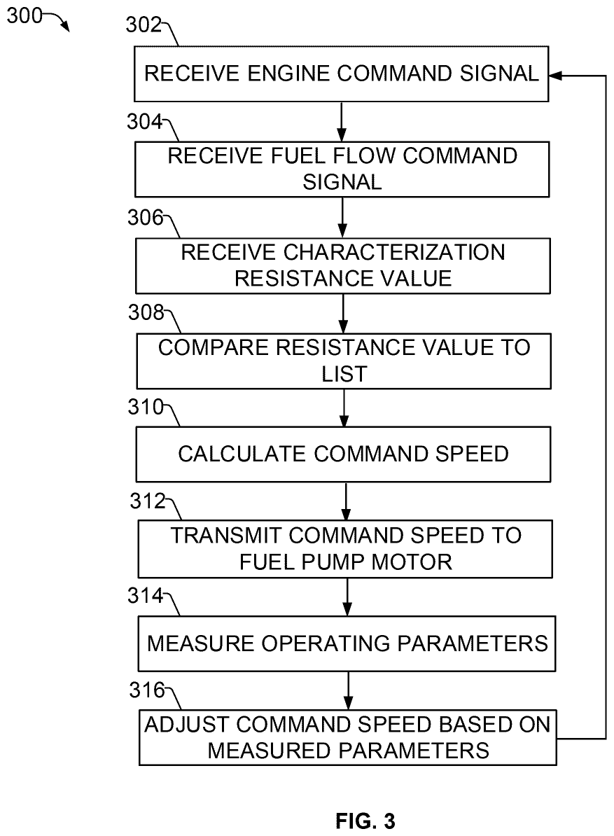

FIG. 3 is a flowchart illustrating example method 300 of regulating fuel delivery to an engine by following a number of process steps and/or executing machine-readable instructions, such as stored on a non-transitory machine-readable storage device, in accordance with the systems and concepts described with respect to FIGS. 1 to 2B.

In block 302, a command signal (e.g., from a user interface or engine controller) is received (e.g., at engine controller 12) to operate the engine (e.g., engine 30).

In block 304, a fuel flow command is received (e.g., via communications link 34) at the fuel pump motor controller 14 from the engine controller to, the fuel flow command comprising fuel metering data.

In block 306, fuel pump motor controller 14 receives a signal corresponding to a resistance value from characterization device 22. For example, the fuel pump motor controller 14 can send an interrogation signal to fuel pump 18 and read the characterization value from a feedback signal, read a quick response (QR), bar code, radio frequency (RF) tag, and/or other type of indication of the characterization device 22 value or values.

In block 308, the fuel pump motor controller 14 compares (e.g., by processor 36) the resistance value to a listing of resistance values (e.g., stored in list 38) corresponding to volumetric efficiency of a fuel pump.

In block 310, the fuel pump motor controller 14 calculates (e.g., by processor 36) a command speed of the fuel pump motor 20; and

In block 312, the fuel pump motor controller 14 regulates electrical power (e.g., via channel 32) to control the fuel pump motor 20 to regulate delivery of fuel to the engine 30 based in part on the command speed. For instance, the command speed signal controls a speed (rpms) of the fuel motor pump to deliver the fuel based on the fuel metering data.

In additional or optional block 314, one or more sensors (e.g., sensors 26) measure a one or more operating parameters (e.g., temperature, pressure, density, flow rate, etc.) of the fuel and/or fuel pump motor. In block 316, the fuel pump motor controller 14 receives the sensor data and calculates an adjustment to the fuel pump motor command speed accordingly.

The process then returns to block 302 to continue monitoring for engine commands and/or sensor data during operation.

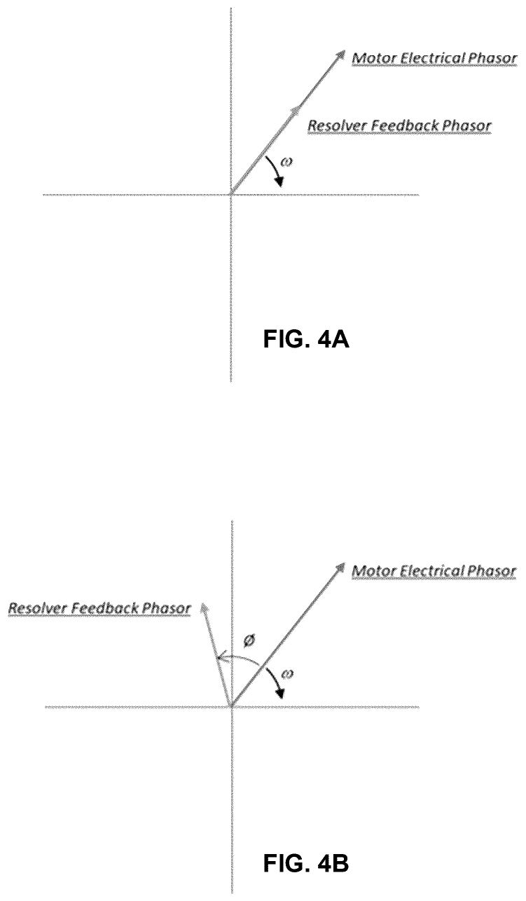

FIGS. 4A and 4B illustrate an example technique to determine volumetric efficiency of a pump by referencing a motor electrical phasor of the pump. For example, some motors (such as brushless permanent magnet motors) often include a rotor position sensor (e.g., sensor 44) or a resolver (e.g., resolver 50), which may be used for commutation. Example rotor position sensors include a Hall Effect encoder. In some examples, during motor assembly the sensor/resolver is calibrated such that a resolver feedback phasor is aligned with the rotational position of the motor electrical phasor, as shown in FIG. 4A. The motor controller (e.g., controller 14) then uses the resolver feedback phasor position to control and time application of currents to the motor operating at a rotational speed to in order to achieve the desired motor operation.

For instance, motor controllers (e.g., controllers 12, 14) may contain ‘autotune’ logic configured to detect and measure offsets between the resolver feedback phasor and the motor electrical phasor/rotation. Here, the offset angle, Ø, is fixed for the life of the motor. The controller stores the offset angle (e.g., in list 38) and is able to control and time application of currents to the motor as if the resolver had been physically calibrated. This logic routine simplifies motor assembly by eliminating the need for resolver calibration.

With this offset value, in an alternative or addition implementation employing a resistor for unit characterization, a predetermined resolver offset can be calibrated and assigned to the motor-pump during assembly. With reference to Equation 2, discrete K values as a function of offset angle are employed instead of resistor value (e.g., K(Ø) instead of K(R)). In some examples, this technique is implemented via an autotune type function, maintaining the physical resolver calibration while providing benefits of eliminating the need for a characterization device, associated harness, and control circuitry.

In some disclosed examples, a system to deliver fuel to an engine includes a fuel pump having a fuel pump motor; a characterization device; and a fuel pump motor controller to regulate fuel metering. The fuel pump motor controller operable to receive a value from the characterization device; receive a fuel flow command from the engine; compare the value to a listing of values corresponding to volumetric efficiency of a fuel pump; calculate a command speed of the fuel pump motor; and control the fuel pump motor to regulate delivery of fuel to the engine based in part on the command speed.

In some examples, the characterization device is integrated with the fuel pump.

In some examples, the fuel pump motor is a brushless direct current (DC) motor, a brushed DC motor, a permanent magnet synchronous motor, or an induction motor.

In examples, a fuel tank is connected to the fuel pump.

In some examples, the system includes one or more of a pressure sensor or a temperature sensor.

In some examples, the system includes an engine controller operable to receive a command signal to operate the engine; and transmit the fuel flow command to the fuel pump motor controller, the fuel flow command comprising fuel metering data.

In examples, the fuel pump motor controller is operable to control a speed of the fuel motor pump to deliver the fuel based on the fuel metering data.

In some examples, the characterization device is a resistor with a resistance that includes one or more discrete resistance values.

In examples, the fuel pump motor controller is further operable to: receive a first resistance value of the one or more discrete resistance values to determine a type of pump; and receive a second resistance value of the one or more discrete resistance values to calculate the volumetric efficiency of the fuel pump motor.

In some examples, the system includes a transmission to modify speed of the flow of fuel from the fuel pump at a given speed of the fuel pump motor.

In examples, the transmission includes one or more of a clutch or gears.

In some examples, the characterization device includes a distance sensor to measure a distance between one or more components of the fuel pump.

In examples, the distance sensor comprises one or more of a linear variable differential transformer (LVDT) or a hall-effect sensor.

In examples, the system includes a distance adjuster to set the distance. In examples, the distance adjuster comprises a threaded distance adjuster.

In some disclosed examples, a system to deliver fuel to an engine includes a fuel pump having a fuel pump motor; one or more sensors to measure pump output; and a fuel pump motor controller to regulate fuel metering. The fuel pump motor controller operable to receive a pump output value from the one or more sensors; calculate volumetric efficiency of the fuel pump based on the pump output value; calculate a command speed of the fuel pump motor based on the volumetric efficiency; and control the fuel pump motor to regulate delivery of fuel to the engine based in part on the command speed.

In some examples, the one or more sensors is a pressure sensor to measure pump output as fluid flow or pressure from the fuel pump.

In some examples, the system includes a variable downstream restriction device to adjust an output pressure of the fuel pump.

In examples, the variable downstream restriction device comprises an adjustable valve.

In examples, the fuel pump motor controller is configured to measure the pump output during an engine start up or calibration sequence.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A system to deliver fuel to an engine, the system comprising:
a fuel pump having a fuel pump motor;
a characterization device; and
a fuel pump motor controller to regulate fuel metering, the fuel pump motor controller operable to:
receive a value from the characterization device;
receive a fuel flow command from the engine;
compare the value to a listing of values corresponding to volumetric efficiency of a fuel pump;
calculate a command speed of the fuel pump motor; and
control the fuel pump motor to regulate delivery of fuel to the engine based in part on the command speed.

2. The system as defined in claim 1, wherein the characterization device is integrated with the fuel pump.

3. The system as defined in claim 1, wherein the fuel pump motor is a brushless direct current (DC) motor, a brushed DC motor, a permanent magnet synchronous motor, or an induction motor.

4. The system as defined in claim 1, further comprising a fuel tank connected to the fuel pump.

5. The system as defined in claim 1, further comprising one or more of a pressure sensor or a temperature sensor.

6. The system as defined in claim 1, further comprising an engine controller operable to:
receive a command signal to operate the engine; and
transmit the fuel flow command to the fuel pump motor controller, the fuel flow command comprising fuel metering data.

7. The system as defined in claim 6, wherein the fuel pump motor controller is operable to control a speed of the fuel motor pump to deliver the fuel based on the fuel metering data.

8. The system as defined in claim 1, wherein the characterization device is a resistor with a resistance that includes one or more discrete resistance values.

9. The system as defined in claim 8, wherein the fuel pump motor controller is further operable to:
receive a first resistance value of the one or more discrete resistance values to determine a type of pump; and
receive a second resistance value of the one or more discrete resistance values to calculate the volumetric efficiency of the fuel pump motor.

10. The system as defined in claim 1, further comprising a transmission to modify speed of the flow of fuel from the fuel pump at a given speed of the fuel pump motor.

11. The system as defined in claim 10, wherein the transmission includes one or more of a clutch or gears.

12. The system as defined in claim 1, wherein the characterization device includes a distance sensor to measure a distance between one or more components of the fuel pump.

13. The system as defined in claim 12, wherein the distance sensor comprises one or more of a linear variable differential transformer (LVDT) or a hall-effect sensor.

14. The system as defined in claim 12, further comprising an distance adjuster to set the distance.

15. The system as defined in claim 14, wherein the distance adjuster comprises a threaded distance adjuster.

16. A system to deliver fuel to an engine, the system comprising:
a fuel pump having a fuel pump motor;
one or more sensors to measure pump output; and
a fuel pump motor controller to regulate fuel metering, the fuel pump motor controller operable to:
receive a pump output value from the one or more sensors;
calculate volumetric efficiency of the fuel pump based on the pump output value;
calculate a command speed of the fuel pump motor based on the volumetric efficiency; and
control the fuel pump motor to regulate delivery of fuel to the engine based in part on the command speed.

17. The system as defined in claim 16, wherein the one or more sensors is a pressure sensor to measure pump output as fluid flow or pressure from the fuel pump.

18. The system as defined in claim 16, further comprising a variable downstream restriction device to adjust an output pressure of the fuel pump.

19. The system as defined in claim 18, wherein the variable downstream restriction device comprises an adjustable valve.

20. The system as defined in claim 16, wherein the fuel pump motor controller is configured to measure the pump output during an engine start up or calibration sequence.
